(19) United States
(12) Patent Application Publication
(10) Pub. No.: US 2003/0220514 A1
(43) Pub. Date: Nov. 27, 2003

(54) Method for preparing a contact mass

(75) Inventors: Larry Neil Lewis, Scotia, NY (US); Paul William Buckley, Scotia, NY (US); John Mathew Bablin, Amsterdam, NY (US); Paul Russell Wilson, Latham, NY (US); David John Smith SR., Cobleskill, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 10/150,829

(22) Filed: May 20, 2002

(51) Int. Cl. C07F 7/02; C22C 29/00

(52) U.S. Cl. 556/473; 420/578

(57) ABSTRACT

A method of preparing a contact mass is provided comprising reacting silicon and a cuprous chloride to form a concentrated, catalytic contact mass. Furthermore, a method for making an alkylhalosilane using the aforementioned contact mass is provided comprising effecting reaction between an alkyl halide and silicon in the presence of said concentrated contact mass to produce alkylhalosilane.

### BACKGROUND OF THE INVENTION

The present invention relates to a method for preparing a contact mass. More particularly, the present invention relates to a method for preparing a contact mass for the direction reaction of powdered silicon, alkyl halide and copper catalyst.

Rochow, U.S. Pat. No. 2,380,995 discloses preparing a mixture of alkylhalosilanes by a direct reaction between powdered silicon and an alkyl halide in the presence of a copper-silicon alloy. This reaction is commonly referred to as the “direct method” or “direct process.” The reaction can be summarized as follows:

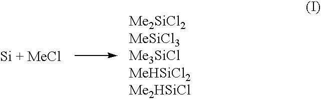

where Me is methyl.

In addition to the above methylchlorosilanes, “residue” is also formed during the production of methylchlorosilane crude. Residue means products in the methylchlorosilane crude having a boiling point greater than about 70° C., at atmospheric pressure. Residue consists of materials such as disilanes for example, symmetrical 1,1,2,2-tetrachlorodimethyldisilane; 1,1,2-trichlorotrimethydisilane; disiloxanes; disilymethylenes; and other higher boiling species for example, trisilanes; trisiloxanes; trisilmethylenes; etc.

Generally, it is desirable to yield high rates of production in the methylchlorosilane reaction as well as selectively produce dimethyldichlorosilane over the other products. New techniques are constantly being sought to improve the alkylhalosilane reaction as well as increase the yield of the alkylhalosilane products.

### BRIEF SUMMARY OF THE INVENTION

The present invention provides a method of preparing a contact mass, comprising reacting a silicon and a cuprous chloride to form a concentrated, catalytic contact mass.

A further embodiment of the present invention provides a method for making an alkylhalosilane, comprising forming a mass by mixing silicon and cuprous chloride to produce a concentrated contact mass and effecting reaction between an alkyl halide and silicon in the presence of said concentrated contact mass to produce alkylhalosilane.

### DETAILED DESCRIPTION OF THE INVENTION

In the present invention, a contact mass for producing alkylhalosilanes is prepared by reacting silicon and cuprous chloride. The reaction product of the silicone and cuprous chloride produces a mixture of Cu, Cu₅Si, and Cu₃Si in a concentrated amount. The resulting solid contains silicon and copper and is called a contact mass. “Concentrated” as used herein refers to a contact mass that can provide a copper content in a range between about 5% by weight and about 60% relative to the entire contact mass, preferably in a range between about 15% by weight and about 40% by weight. The silicon and cuprous chloride are reacted until evolution of silicon tetrachloride (SiCl₄) ceases. The contact mass is typically contacted with alkyl halide to generate alkylhalosilane, known herein as the “alkylhalosilane reaction”. The concentrated contact mass makes it unnecessary to use a copper catalyst during the alkylhalosilane reaction. Thus, the reaction is free from additional sources of copper independent from the contact mass.

Silicon used in the contact mass can have an iron (Fe) content in a range between about 0.1% and 1% by weight based on total silicon, calcium (Ca) content in a range between about 0.01% and 0.2% by weight based on total silicon, and an aluminum (Al) content in a range between about 0.02% and 0.5% by weight based on total silicon. The silicon typically has a particle size below about 700 microns, with an average size greater than about 20 microns and less than about 300 microns. The mean diameter of the silicon particles is preferably in the range between about 100 microns and about 150 microns. Silicon is usually obtained at a purity of at least 98% by weight of silicon and it is then comminuted to particles of silicon in the above-described range for preparation of the contact mass.

During the alkylhalosilane reaction, catalysts such as zinc, tin, and antimony may be used. Zinc metal, halides of zinc, for example zinc chloride and zinc oxide have been found effective as components of the catalyst of the mass. Zinc (Zn) may be present in a range between about 0.01 weight % and about 1 weight % relative to the contact mass. Tin metal dust (−325 ASTM mesh), tin halides, such as tin tetrachloride, tin oxide, tetramethyl tin, and alkyl tin halide, and combinations thereof also can be used as a source of tin for making a catalyst component of the mass. Tin (Sn) may be present in a range between about 10 parts per million and about 100 parts per million relative to the contact mass.

The alkylhalosilane reaction is typically run with an additional promoter such as phosphorus. When phosphorus is a component of the contact mass, it is typically present in a range between about 100 parts per million and about 1000 parts per million relative to the entire contact mass.

When phosphorus is added to the reactor bed, it can be supplied from a variety of sources. For instance, the phosphorus source can be copper phosphide, zinc phosphide, phosphorus trichloride, alkylphosphines such as triethylphosphine or trimethylphosphine or combinations thereof. With or without added phosphorus, the T/D ratio decreases with the addition of the heat-treated contact mass.

Although methyl chloride is preferably used in the alkylhalosilane of the present invention, other C₍₁₋₄₎ alkylchlorides, for example ethyl chloride, propyl chloride, etc., can be used. Correspondingly, the term “alkylhalosilane” includes dimethyldichlorosilane referred to as “D” or “Di”, which is the preferred methylchlorosilane referred to as “T” or “Tri”, and a variety of other silanes such as tetramethylsilane, trimethylchlorosilane, methyltrichlorosilane, silicon tetrachloride, trichlorosilane, methyldichlorosilane and dimethylchlorosilane. Dimethyldichlorosilane and methylchlorosilane are the major products of the alkylhalosilane reaction, which typically produces dimethyldichlorosilane in a range between about 80% and about 88% and methyltrichlorosilane in a range between about 5% and about 10%. Dimethyldichlorosilane has the highest commercial interest. A T/D ratio is the weight ratio of methyltrichlorosilane to dimethyldichlorosilane in the crude methylchlorosilane reaction product. An increase in the T/D ratio indicates that there is a decrease in the production of the preferred dimethyldichlorosilane. Hence, the T/D product ratio is the object of numerous improvements to the direct reaction.

In the alkylhalosilane reaction, the contact mass added should be reacted with unreacted silicon in order that the copper in the concentrated contact mass catalyze the alkylhalosilane reaction. “Unreacted silicon” as used herein refers to silicon that has not been reacted with any alkyhalosilane reaction component. Copper transfer to fresh silicon is determined as follows. The amount of alkylhalosilane crude that can be formed from the silicon in the initial concentrate derived from the reaction of cuprous chloride and silicon is determined, Cᵢ. The copper transfer (Cu_{Tp}) point is the time when more alkylhalosilane crude than Cᵢ is formed. At the Cu_{Tp} the added silicon must be forming alkylhalosilane and it is assumed that the copper in the original concentrate has thus transferred to fresh silicon at that point (since methylchlorosilane from the silicon in the initial concentrate is accounted for). Thus an effective catalyst is one with a relatively short Cu_{Tp} while an ineffective catalyst has a long Cu_{Tp}. It was unexpectedly found that shorter Cu_{Tp} values were obtained using the Cu—Si compositions of the present invention vs. a mixture of commercial MCS copper flake catalyst.

The contact mass of the present invention may be produced in a stirred vessel, a stirred bed reactor, a fluidized bed reactor, or a fixed bed reactor. The contact mass of the present invention can be made by introducing the silicon and cuprous chloride components into a reactor separately or as a mixture, master batch, alloy or blend of the various components in elemental form or as compounds or mixtures and heated to a temperature in a range between about 250° C. and about 350° C., and preferably between about 280° C. and about 320° C. Once formed, the concentrated catalytic contact mass can be transferred to an alkylhalosilane reactor and used as the copper source for said reactor. Alternatively, the alkylhalosilane reaction may be subsequently practiced in the reactor in which the contact mass was prepared.

Commonly, the alkylhalosilane reaction may be practiced in a fixed bed reactor. However, the alkylhalosilane reaction can be conducted in other types of reactors, such as fluid bed and stirred bed. More specifically, the fixed bed reactor is a column that contains silicon particles through which alkyl halide gas passes. A stirred bed is similar to a fixed bed in which there is mechanical agitation of some sort in order to keep the bed in constant motion. A fluidized bed reactor typically includes a bed of the contact mass, silicon particles, catalyst particles and promoter particles, which is fluidized; i.e., the silicon particles are suspended in the gas, typically methylchloride, as it passes through the reactor. The alkylhalosilane reaction typically occurs under semi-continuous conditions or in batch mode at a temperature in a range between about 250° C. and about 350° C., and preferably between about 280° C. and about 320° C. It is also advisable to carry out the reaction under a pressure in a range between about 1 atmospheres and about 10 atmospheres in instances where a fluid bed reactor is used since higher pressure increases the rate of conversion of methyl chloride to methylchlorosilanes. Desirably, the pressure is in a range between about 1.1 atmospheres and about 3.5 atmospheres and preferably in a range between about 1.3 atmospheres and about 2.5 atmospheres.

The expression “semi-continuous conditions” with respect to the description of the reaction of methyl chloride and a contact mass means that reaction solids are added and the reactor is run until about 50% of the silicon has been utilized. After about 50% utilization, additional reactants of silicon, catalysts and promoters may be added. With a batch mode reaction, all of the solid components are combined and reacted with any reactants until most of the reactants are consumed. In order to proceed, the reaction has to be stopped and additional reactants added. A fixed bed and stirred bed are both run under batch conditions.

In order that those skilled in the art will be better able to practice the invention, the following examples are given by way of illustration and not by way of limitation.

### EXAMPLE 1

Preparation of Copper-Silicon Concentrate.

Silicon powder (170.11 g) was combined with cuprous chloride (CuCl, 46.88 g) in a 500 milliliter (mL) resin kettle equipped with an overhead stirrer, a thermal couple, and a condenser. The resin kettle was heated under a constant flow of argon to 300° C. for 1 hour at which time a solid sample was removed. The kettle was then heated to about 310° C. for 3 hours and a solid sample was removed. Finally the kettle was heated to 337° C. for 2 hours and the reaction was stopped. X-ray diffraction (XRD) analysis of the samples taken at 300° C., between 315° C. and 325° C., and at the end of the reaction showed that the solids were equivalent in composition and contained no CuCl but did contain the aforementioned mixture of Cu, Cu₅Si, and Cu₃Si. Results can be seen in Table 1.

### EXAMPLE 2

A 450 mL high pressure Parr® reactor, constructed of Hastelloy-C was equipped with a stirrer, water cooled coiling coil, 45 degree pitched blade impeller, thermowell, gas inlet, diptube, reactor vent line, 2000 psig rated rupture disc assembly, and an electric heating mantle. The reactor was charged with 217 grams solids, targeting a yield of about 200 g of 20% copper concentrated copper-silicone contact mass. The reaction was performed at 300° C. with a constant Argon (Ar) sparge which entered the reactor vessel through the dip tube in the bottom of the reactor and exited the vessel through the vent valve on the reactor head. Argon sparging was done to ensure proper mixing and stirring of the solid during the reaction. During the experiment, the exit valve was opened to control the gas flow through the reactor from underneath the reactor and then raised 10° C. every hour. Solid samples were removed at each temperature. XRD analysis showed that CuCl was completely converted to a mixture of Cu, Cu₅Si, and Cu₃Si even at a temperature of 300° C. Results can be seen in Table 1.

### EXAMPLE 3

A 5 gallon Hastelloy-C kettle equipped with a magnetically driven stirrer, an argon purge, thermocouples to monitor the bed temperature, and an outlet connected to a water-cooled condenser was charged with 14.5 kg of silicon and 5.7 kg of copper chloride. The kettle was stirred at 300 rpm and the temperature was raised to 310° C. When the temperature reached between 285° C. and 315° C. the thermocouple temperature increased and silicon tetrachloride was formed and collected at the condenser. Maximum temperature noted was 373° C. after approximately 20 minutes. Silicon tetrachloride was collected but not measured and 17.2 kg of solid was recovered from the kettle after cooling, 96.5% of theoretical. The solid was analyzed by X-ray diffraction and the results are shown in Table 1.

### EXAMPLE 4

A 5 gallon Hastelloy-C kettle equipped with a magnetically driven stirrer, an argon purge, thermocouples to monitor the bed temperature, and an outlet connected to a water-cooled condenser was charged with 12.2 kg of silicon and 12.2 kg of copper chloride. The kettle was stirred at 200 rpm and the temperature was raised to 310° C. When the temperature reached between 285° C. and 315° C. the thermocouple temperature was increased and silicon tetrachloride was formed and collected at the condenser. Maximum temperature noted was 595° C. after approximately 15 minutes. A total of 4.67 kg of silicon tetrachloride was collected and 18.5 kg of solid was recovered from the kettle after cooling, 97.4% of theoretical. The solid was analyzed by X-ray diffraction and the results are shown in Table 1.

TABLE 1
X-ray Diffraction data for Cu—Si Mixtures

| | CuCi | | | |
|---|---|---|---|---|
| | (2Θ = | Cu5Si | Cu | Cu3Si |
| Sample | 33.026°) | (2Θ = 43.692°) | (2Θ = 43.297°) | (2Θ = 45.246°) |
| ID | Intensity | Intensity | Intensity | Intensity |
| Example 1 | — | 506 | 530 | 624 |
| Example 2 | — | 63 | 75 | 141 |
| Example 3 | — | 125 | * | 449 |
| Example 4 | — | 48 | 117 | 200 |

*The presence of the Cu phase is questionable, as the position of the peak normally observed at 2-theta = 43.297 can easily be justified as background noise instead of a Cu peak. If this phase is present, it may be in a negligible quantity.

Fluid Bed Reactor: The reactor was a 3.8 cm inner-diameter (ID) glass tube with a glass frit at the center to support the silicon bed. The reactor was heated in the same way as the fixed bed reactor, namely by a second concentric 5.1 cm ID glass tube coated with tin oxide to which two pairs of electrodes were attached to create two heated sections.

In order to fluidize the silicon it was necessary both to stir the reacting silicon and to vibrate the reactor. Vibration was accomplished by attaching one end of a clamp to the reactor, and the other end to the base of a variable intensity test tube shaker. By adjusting the intensity of the vibration and the firmness with which the clamp gripped the reactor, the necessary agitation of the silicon bed was achieved. Typically the vibration was used intermittently during a run.

Running the Fluid Bed Reactor: All reactions of approximately 20 grams of contact mass were performed at 300° C. or 310° C. as measured by a thermocouple immersed in the contact mass. The reactor was fed MeCl at 93 to 97 SCCM. Product silanes were collected across a condenser system maintained at −20° C.

The operating procedure was typically as follows: The reactor and downstream glassware heating and cooling systems were brought to their set points and the reactor was first purged with Ar (30 min at 95 SCCM) and then MeCl (1 hr at 95 SCCM). After purging, the contact mass was charged into the reactor through a funnel. Following the addition of the contact mass, the reactor stirring and vibration was begun.

Several copper-silicon concentrates produced from the description above were blended with non-copper containing silicon to produce a contact mass of 4.5 weight % to 5.0 weight % Cu. Additional amounts of zinc and tin dust, 30 and 1 mg respectively, were also added to the contact mass.

### EXAMPLE 5

A copper-silicon concentrate as prepared in example 1, composed of 16.5 weight % Cu was blended with 3 parts of silicon along with the zinc and tin dust to form the contact mass. The contact mass was exposed to MeCl at 350° C. and produced silanes. It was determined that after 26 hours the copper from the copper-silicon concentrate had transferred to the added silicon that was copper free. The cumulative silanes produced from this example are reported in table 2.

### EXAMPLE 6

A copper-silicon concentrate from example 2 composed of 20.0 weight % Cu was blended with 3 parts of silicon along with the zinc and tin dust to form the contact mass. The contact mass was exposed to MeCl at 330° C. and produced silanes. It was determined that after 16 hours the copper from the copper-silicon concentrate had transferred to the added silicon that was copper free. The cumulative silanes produced from this example are reported in table 2.

### EXAMPLE 7

A copper-silicon concentrate from example 3 composed of 20.0 weight % Cu was blended with 3 parts of silicon along with the zinc and tin dust to form the contact mass. The contact mass was exposed to MeCl at 330° C. and produced silanes. It was determined that after 11 hours the copper from the copper-silicon concentrate had transferred to the added silicon that was copper free. The cumulative silanes produced from this example are reported in table 2.

### EXAMPLE 8

A copper-silicon concentrate from example 4 composed of 40.0 weight % Cu was blended with 7 parts of silicon along with the zinc and tin dust to form the contact mass. The contact mass was exposed to MeCl at 330° C. and produced silanes. It was determined that after 5.8 hours the copper from the copper-silicon concentrate had transferred to the added silicon that was copper free. The cumulative silanes produced from this example are reported in table 2.

### EXAMPLE 9

### Comparative Example

50 grams of a copper-silicon concentrate composed of 40.0 weight % Cu using commercial copper flake (EC-300 from GE Silicones Ohta, Japan) was prepared by blending 20 grams of copper metal flake with 30 grams of silicon. This blend was then added to the fluid bed reactor and exposed to an argon flow at 93 to 97 SCCM at 320° C. for 3.5 hours. A total of 49.15 grams of the copper-silicon concentrate was recovered, 98.3% of theoretical. 2.5 grams of this copper-silicon concentrate were blended with 17.5 g of silicon along with zinc and tin dust, 30 and 1 mg respectively, to form the contact mass. The contact mass was exposed to MeCl at 93 to 97 SCCM at 330° C. and produced silanes. It was determined that the Cu_{Tp} occurred at approximately 13.5 hours as reported in table 3, which was longer than that found in example 8. The cumulative silanes produced from this example are reported in table 2.

TABLE 2

| | % Si | | | | |
|---|---|---|---|---|---|
| Example | Utilization | Di | T/D ratio | MH & M₂H* | Residue |
| 5 | ˜37 | 71.0 | 0.211 | 6.66 | 5.7 |
| 6 | ˜37 | 78.6 | 0.120 | 2.26 | 6.4 |
| 7 | ˜37 | 79.9 | 0.111 | 2.07 | 5.8 |
| 8 | ˜37 | 78.9 | 0.131 | 1.84 | 6.0 |
| 9 | ˜37 | 79.6 | 0.136 | 2.15 | 4.8 |

*Where MH is MeHSiCl₂ and M₂H is Me₂HsiCl.

TABLE 3
Summary of Cu_{Tp}'s

| | | | MCS reaction | Approx. |
|---|---|---|---|---|
| | CCM Type/ | Initial MCS | Temp during | time to |
| Example | Blend w/Si | reaction temp. | Cu_{TP} | Cu_{TP} (hrs) |
| 5 | 16.5%/1:3 | 330° C. | 350° C. | 26 |
| 6 | 20.0%/1:3 | 330° C. | 330° C. | 16 |
| 7 | 20.0%/1:3 | 330° C. | 330° C. | 11 |
| 8 | 40.0%/1:7 | 330° C. | 330° C. | 5.8 |
| 9 | 40.0%/1:7 | 330° C. | 330° C. | 13.5 |

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

What is claimed is:

1. A method of preparing a contact mass, comprising reacting a silicon and a cuprous chloride to form a concentrated, catalytic contact mass.

2. The method in accordance with claim 1, wherein the concentrated, catalytic contact mass comprises a final copper concentration in a range between about 5% by weight and about 60% by weight relative to the entire contact mass.

3. The method in accordance with claim 2, wherein the concentrated, catalytic contact mass comprises a final copper concentration in a range between about 15% by weight and about 40% by weight relative to the entire contact mass.

4. The method in accordance with claim 1, wherein the contact mass comprises a mixture of copper, Cu₅Si, and Cu₃Si.

5. The method in accordance with claim 1, wherein the silicone and cuprous chloride reaction produces a silicon tetrachloride by-product.

6. The method in accordance with claim 1, wherein the reaction occurs at a temperature in a range between about 250° C. and about 350° C.

7. The method in accordance with claim 6, wherein the reaction occurs at a temperature in a range between about 280° C. and about 320° C.

8. The method in accordance with claim 1, wherein the silicon is powdered.

9. A method of preparing a contact mass, comprising reacting a silicon powder and a cuprous chloride at a temperature in a range between about 280° C. and about 320° C. to form a concentrated, catalytic contact mass wherein the concentrated, catalytic contact mass comprises a final copper concentration in a range between about 15% by weight and about 40% by weight relative to the entire contact mass.

10. A method for making an alkylhalosilane, comprising forming a mass by mixing silicon and cuprous chloride to produce a concentrated contact mass and effecting reaction between an alkyl halide and silicon in the presence of said concentrated contact mass to produce alkylhalosilane.

11. The method in accordance with claim 10, wherein the reaction between the alkyl halide and silicone in the presence of the concentrated contact mass is substantially free of forms of copper other than the forms of copper in the concentrated contact mass.

12. The method in accordance with claim 10, wherein the concentrated, catalytic contact mass comprises a final copper concentration in a range between about 5% by weight and about 60% by weight relative to the entire contact mass.

13. The method in accordance with claim 12, wherein the concentrated, catalytic contact mass comprises a final copper concentration in a range between about 15% by weight and about 40% by weight relative to the entire contact mass.

14. The method in accordance with claim 10, wherein the contact mass comprises a mixture of copper, Cu₅Si, and Cu₃Si.

15. The method in accordance with claim 10, wherein the silicone and cuprous chloride reaction produces a silicon tetrachloride by-product.

16. The method in accordance with claim 10, wherein the reaction occurs at a temperature in a range between about 250° C. and about 350° C.

17. The method in accordance with claim 16, wherein the reaction occurs at a temperature in a range between about 280° C. and about 320° C.

18. The method in accordance with claim 10, wherein the silicon is powdered.

19. The method in accordance with claim 10, wherein the alkylhalosilane reaction further comprises a zinc-tin catalyst.

20. The method in accordance with claim 10, wherein said alkyl halide comprises methyl chloride.

21. The method in accordance with claim 20, wherein said alkylhalosilane comprises dimethyldichlorosilane.

22. The method in accordance with claim 10, wherein said reaction is conducted in a fluid bed reactor.

23. The method in accordance with claim 10, wherein said reaction is conducted in a fixed bed reactor.

24. The method in accordance with claim 10, wherein said reaction is conducted in a stirred bed reactor.

25. A fluid bed reactor containing a contact mass prepared according to the method of claim 10.

26. A fixed bed reactor containing a contact mass prepared according to the method of claim 10.

27. A stirred bed reactor containing a contact mass prepared according to the method of claim 10.

28. A method for making dimethyldichlorosilane, comprising reacting a silicon powder and a cuprous chloride at a temperature in a range between about 280° C. and about 320° C. to form a concentrated, catalytic contact mass wherein the concentrated, catalytic contact mass comprises a final copper concentration in a range between about 15% by weight and about 40% by weight relative to the entire contact mass; and
effecting reaction between a methyl chloride and silicon in the presence of said concentrated contact mass to produce dimethyldichlorosilane.
